(19) United States
(12) Patent Application Publication
(10) Pub. No.: US 2010/0055333 A1
(43) Pub. Date: Mar. 4, 2010

(54) APPARATUS TO PRODUCE COATED PAPER, CARDBOARD OR OTHER FIBROUS WEBS WITH AT LEAST ONE THERMO-SENSITIVE LAYER AND METHOD TO OPERATE AN APPARATUS OF THIS TYPE

(76) Inventors: Michael Trefz, Heidenheim (DE); Thomas Kuchinke, Schwabisch-Gmund (DE)

Correspondence Address: TAYLOR & AUST, P.C., P.O. Box 560, 142. S Main Street, Avilla, IN, 46710, US

(21) Appl. No.: 12/542,907

(22) Filed: Aug. 18, 2009

(30) Foreign Application Priority Data
Aug. 28, 2008 (DE) 10 2008 041 422.0

(51) Int. Cl. B05D 3/00; B05C 13/02

(52) U.S. Cl. 427/372.2; 118/58

(57) ABSTRACT

The invention relates to an apparatus to produce coated paper, cardboard or other fibrous webs with at least one thermo-sensitive layer as a plurality of functional layer through the application of at least one thermo-sensitive coating medium onto a carrier web by way of a functional layer forming unit, including at least one applicator device and one drying section. The first functional forming unit includes an applicator device in the embodiment of a multi-layer curtain coater with at least one delivery nozzle and a drying section located after it. The second functional layer forming unit also includes an applicator device in the embodiment of a multi-layer curtain coater with at least one delivery nozzle and one drying section located after it, there is a first web path that including the applicator device of the second functional layer forming unit, as well as a second web path and means to bypass the applicator device are provided.

### BACKGROUND OF THE INVENTION

1. Field of the Invention

The invention relates to an apparatus to produce coated paper, cardboard or other fibrous webs with at least one thermo-sensitive layer as a functional layer through the application of at least one liquid or paste-like thermo-sensitive coating medium onto a carrier web by a functional layer forming unit. The invention also relates to a method to operate an apparatus for the production of coated paper, cardboard or other fibrous webs with at least one thermo-sensitive layer.

2. Description of the Related Art

“Carrier webs” are to be understood to be webs which are coated with at least one thermo-sensitive layer on one side or on both sides. However, also other webs that are suitable for recording mediums, such as films, especially plastic films or textile webs can be treated according to the invention.

A thermo-sensitive layer is to be understood to be a coating layer which, under the effect of heat, especially through contact with a heatable printing head is suitable to provide an image of visually recognizable information by way of a color change. This includes at least one color generator, one color developer and a fixing agent.

Apparatuses to produce coated paper, cardboard or other fibrous webs with at least one thermo-sensitive layer in the form of thermo papers through application of a liquid or paste-like thermo-sensitive coating medium onto a carrier web by way of a curtain coater are already known for example from
La papeterie 275, April-May 2006, pages 6-14 and
Revue de Papier Carton #85, February-March 2006, pages 34-37

Here, a dryer section is located after the applicator device which is in the embodiment of a curtain coater. In order to avoid curling, water is applied to the backside to improve laying flat. With this type of basic configuration a single thermo-sensitive layer can be applied. Further developments in the area of thermo papers and the expansion of the scope of application have however led to the development of high quality thermo papers. These are coated either on both sides with one thermo-sensitive coating or feature a cover layer as a protective layer over the thermo-sensitive layer. In order to achieve these additional functional layers, units which form functional layers are provided in accordance with the number of individual layers. These units include applicator devices with coating medium supply systems allocated to them, followed by a drying section in order to ensure the required dry content. Such devices are however characterized by a considerable space requirement and, because of the multitude of functional layer forming units, are cost intensive. However, depending upon the type of coated fibrous web that is to be produced, individual applicator devices and the following drying sections are not used, so that over capacities exist over large parts of the entire operational area and the apparatus is not utilized to its optimum.

What is needed in the art is an apparatus to produce coated paper, cardboard or other fibrous webs, especially in the form of thermo papers, so that the disadvantages are avoided. The apparatus should be characterized by a simple construction using few components and should be capable of coating one carrier web several times on one side, especially multiple times, or capable of coating it on both sides with at least one, preferably two coatings. Change-over to run the different types of coated paper, cardboard or other fibrous webs is to be simple and involve few control changes and should be achieved in a timely manner, without conversion measures to meet current demands.

### SUMMARY OF THE INVENTION

An apparatus to produce coated paper, cardboard or other fibrous webs with at least one thermo-sensitive layer as a functional layer is provided through the application of a thermo-sensitive coating medium onto a carrier web by way of a functional layer forming unit, including an applicator device and a drying section. That the first functional forming unit includes an applicator device in the embodiment of a multi-layer curtain coater with at least one delivery nozzle and a drying section located after it. The second functional layer forming unit also includes an applicator device in the embodiment of a multi-layer curtain coater with at least one delivery nozzle and one drying section located after it. There is a first web path that includes the applicator device of the second functional layer forming unit, as well as a second web path and way to bypass the applicator device are provided.

The inventive apparatus is characterized by the provision of only two functional layer forming units which, due to the intelligent arrangement and control of their operational modes are suitable for producing a multitude of different types of coated paper, cardboard or other fibrous webs which are coated on one side or on both sides with one or multiple layers at low expenditure, without conversion of the apparatus. This provides the opportunity of a quick changeover and optimal utilization of the individual components of the individual functional layer forming units.

In the simplest scenario the device to bypass the applicator device includes guide and/or control elements to guide the carrier web the bypass device is arranged and designed to be suitable to create a branching in the web path after the first functional layer forming unit and before the applicator device of the second functional layer forming unit by creating the first web path over the applicator device, and the second web path in the form of a bypass around the applicator device and a merging of the two web paths. With appropriate web routing and activation of the individual operational components of the functional layer forming units a multitude of possible differently coated paper, cardboard or other fibrous webs are achievable in this arrangement. For example, by completely deactivating the second functional layer forming unit at least one material web, which is coated with one layer on one side, can be produced by activating the curtain coater of the first functional layer forming unit and the following drying section. If a second layer is applied directly onto the first layer, the carrier web is routed over the drying section of the second functional layer forming unit in order to achieve the desired degree of dryness, so that a material web, which has a two-layer coating on one side can be produced by utilizing the drying capacity of the second functional layer forming unit. For this purpose the carrier web may be routed either over the first web path inside the second functional layer forming unit while its applicator device is deactivated or, it may be routed over the second web path, directly to the drying section of the second functional layer forming unit. Additionally the applicator device of the second functional layer forming unit can be activated and the carrier web is routed over the first web path inside it. A coating onto the backside of the carrier web, or an additional third layer on the same side can be applied, depending upon the arrangement and web path between the first and the second functional layer forming units. In the latter case however, the drying capacity of the drying section of the first functional layer forming unit is to be designed for the dual application, so that the required dry content of the coating can be achieved prior to applying the third layer.

The applicator device and the drying section in a functional layer forming unit are configured and arranged so that the carrier web is guided inside at least the first, preferably also the second, functional layer forming unit without a directional change (reversal of the started turn direction) viewed in a longitudinal direction of the apparatus, whereby it is ensured that in each case the coated surface is subjected to a subsequent drying.

There are at least two options with respect to the layout and orientation of the components of the functional layers forming units relative to each other. According to a first arrangement they are arranged in a common horizontal plane, in other words without being offset relative to each other in a vertical direction. According to a second arrangement the layout is offset in a vertical direction relative to each other. The first arrangement offers a very compact unit with regard to height extension, while the second arrangement permits an adaptation to space availability factors.

The layout of the individual functional layer forming units can also differ. According to a first especially advantageous design variation, the layout of the functional layer forming units, viewed in a direction of carrier the web travel are such that they follow each other in such a way that the direction of travel of the carrier web, in the merging region between the two functional layer forming units, is characterized by at least one directional change, as viewed in the longitudinal direction of the apparatus. The provided directional change, especially the loop-type routing, permits an arrangement of the functional layer forming units in planes, offset vertically relative to each other, whereby the offset in the longitudinal direction between the two functional layer forming units can be minimized. The first design variation is characterized by a high degree of compactness in the longitudinal direction and at the same time by optimum usage of the available space in the vertical direction. In an especially advantageous further development of the second embodiment, the placement of the second functional layer forming unit, as viewed spatially in longitudinal direction of the apparatus, occurs completely within the region of extension of the first functional layer forming unit.

According to a second design configuration, both functional layer forming units are designed, and located following each other in the longitudinal direction of the apparatus so that the routing of the carrier web in the longitudinal direction of the apparatus is without reversal of the started turn direction. Both functional layer forming units are preferably located in a horizontal plane.

According to another embodiment of the present invention, the first and the second functional layer forming unit are aligned in opposite directions. Here the carrier web is routed between the two functional layer forming units without further insertion of a web turning device in a manner that it is subjected to a reversal in the orientation of its top and bottom side, especially relative to the respective applicator devices of the individual functional layer forming units. In the simplest case scenario the orientational change of the carrier web, relative to the respective applicator devices of the individual functional layer forming units, occurs by way of a device for directional change in the web path, specific to the longitudinal direction of the apparatus, especially the corresponding arrangement of web the guide rolls.

For the inventive routing of the carrier web over the second functional layer forming unit, two configurations are illustrative of the present invention. According to a first variation the drying section of the second functional layer forming unit may be located either after the device for bypassing the applicator device of the second functional layer forming unit, especially the bypass, or according to a second variation may be located in the bypass. The devices for routing the web in these areas are configured and located such that they permit the web to be directed always in the same direction, according to the first design variation, through the second functional layer forming unit, independent of whether or not the carrier web is routed through the applicator device and subsequently through the drying section. In the second arrangement of the location in the bypass, the drying section is passed through in an opposite direction in the various operational modes which are characterized by the different ways of routing the web over the applicator device, or by bypassing it. Accordingly, the first variation can be configured in an especially space saving manner in that the two functional layer forming units are arranged vertically offset to each other, whereby the location of the applicator device and the drying section between these are switched in longitudinal direction of the apparatus. The second variation permits the placement of the applicator device and the drying section of the second functional layer forming unit in vertically offset planes, without being offset in the longitudinal direction.

The applicator device of the functional layer forming unit includes a multi-layer curtain coater which permits an application of coating medium in the form of a single or multi-layer curtain which is formed and enters into a free fall at a break line in the direction of the carrier web. The curtain coater includes at least one applicator nozzle which extends in a width direction of the carrier web and which is connected with the coating medium supply system through at least one coating medium feed line. The nozzle, or respectively the curtain coater may be in the embodiment of a slot die or slide die, as already known. This permits a simultaneous application of at least two layers with one device.

For quick changeover between different types of coating layers that are to be applied by a curtain coater, at least two coating medium supply systems can be provided which, subject to the demands upon the coating medium may be accessed alternately, for example through selective coupling of the coating medium feed line with the different coating medium supply systems.

The individual drying section of one functional layer forming unit includes at least one drying device, especially in the form of a contactless drying device, for example a hot air drying device. This can be gas or steam heated. Other drying systems, such as infrared radiation and contact drying, such as a dryer cylinder are also contemplated. The drying section is laid out for the purpose of achieving the dry content that is to be achieved in the layer that was applied with the upstream applicator device. The dryer section is preferably straight, however it may also be characterized by a curved, or other progression. Drying may occur on one or on both sides, whereby designs offering selective one- or two-sided operation are contemplated.

In a continuous operational mode the carrier web is usually unwound from a web material roll and pulled through the apparatus by way of appropriate pulling devices. After the second functional layer forming unit rewinding of the coated fibrous web occurs by way of a rewinder. A pulling device is preferably allocated to each functional layer forming unit.

In addition to thermo-sensitive layers, other layers can also be applied as functional layers, for example cover layers in the form of protective layers. The latter are characterized by a lower basis weight in the range of 0.5 to 6 g/m² than the thermo-sensitive layers whose basis weight is selected preferably in the range of 1 to 7 g/m².

In an especially advantageous further development a web turning device is provided between the two functional layer forming units, especially the first functional layer forming unit and the applicator device of the second functional layer forming unit, thus creating a third web path, as well as a means to bypass the web turning device between the two functional layer forming units. Depending upon the design variation, an additional option of orientational change of the top and bottom side of the carrier web can be achieved which, in combination with the additional control options of the individual functional layer forming units permits the application of additional coating layers, thereby multi-layers can be produced on one side of the carrier web, or also on both sides.

In an additional advantageous further development the second applicator device of the second functional layer forming unit also includes a multi-layer curtain coater. Multiple different layers, as desired, can therefore be produced with the second functional layer forming unit.

The inventive solution is especially suitable for the production of thermo-papers. The invention can however also be applied for other materials in web form and which are suitable as recording mediums, such as, for example, films or textiles.

The inventive apparatus can be operated in various operational modes through control of the web path and the individual components of the functional layer forming units. In a first operational mode the carrier web is run successively through the first functional forming layer unit while at least one first layer is formed, and through the second functional layer forming unit while a second layer is formed. In a second operational mode the carrier web is run successively through the first functional layer forming unit while at least one first layer is formed and through the second functional layer forming unit without an application being applied. Depending upon the configuration of the apparatus, carrier webs can be produced which have a single coating on one or on both sides, or a multiple coating on one side. If the carrier web in the second operational mode is routed through the first functional layer forming unit while at least two layers are applied by it, and while utilizing the drying capacity of the second functional layer forming unit the web is routed through the drying section of the second functional layer forming unit, the apparatus can be operated especially energy efficiently. If at least two layers are applied in both functional layer forming units, paper, cardboard or other fibrous webs which are coated with a multiple layer applications on one side, or on both sides can be produced in a simple manner.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

The inventive solution is explained below with reference to the drawings. The following details are illustrated:

FIG. 1a through 1g schematically illustrate cross sections of the composition of different types of coated paper, cardboard or other fibrous webs;

FIG. 2a is a simplified schematic illustration of the basic construction and the basic functions of an embodiment of the present invention of an apparatus for the production of coated paper, cardboard or other fibrous webs with at least one functional layer with vertically offset functional layer forming units whereby the dryer section is located after the merging location;

FIG. 2b is a simplified schematic illustration of the basic construction and the basic functions another embodiment of an apparatus of the present invention for the provision of coated paper, cardboard or other fibrous webs with at least one functional layer with vertically offset functional layer forming units whereby the dryer section of the second unit is located in the bypass to the applicator device;

FIGS. 2c1 and 2c2 illustrate operational modes of the apparatus of FIGS. 2a and 2b in the form of flow diagrams;

FIG. 3 is a simplified schematic illustration of an arrangement of the embodiment of FIG. 2b;

FIG. 4 is a simplified schematic illustration of an arrangement of the embodiment to FIG. 2a;

FIG. 5 is a simplified schematic illustration of an other arrangement according to FIG. 4, including a web turning device;

FIGS. 6a through 6d are flow diagrams to illustrate the operational modes of the apparatus according to FIG. 5, for the production of a material web which is coated on one side; and

FIGS. 7a through 7c are flow diagrams to illustrate the operational modes of the apparatus according to FIG. 5, for the production of a material web which is coated on both sides.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

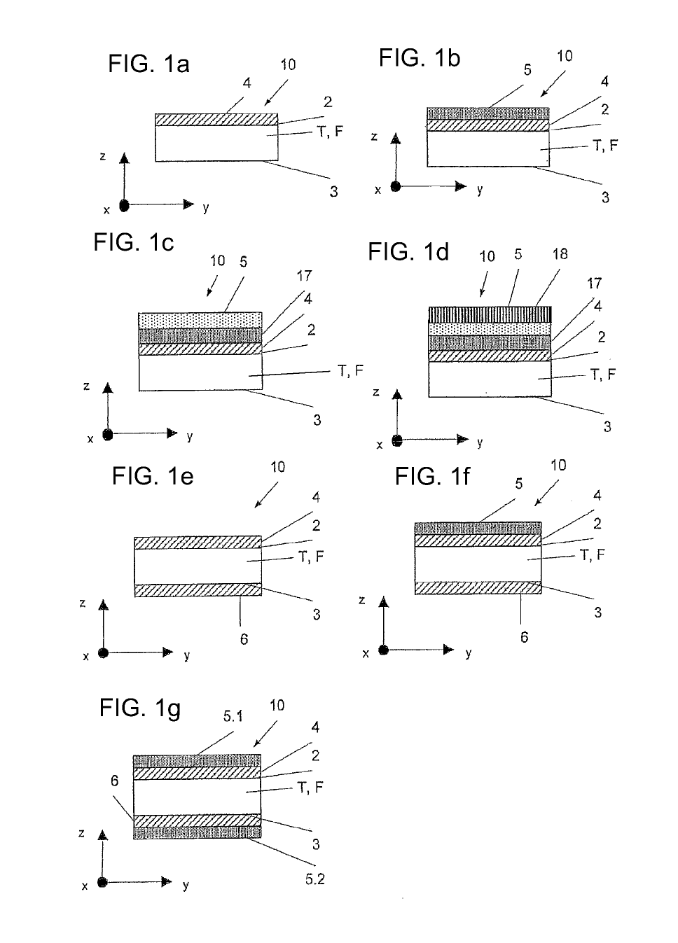

Referring now to the drawings and more particularly to FIG. 1a through 1g there are shown cross sections through a coated fibrous web 10 which depict in greatly simplified illustration configurations of coated fibrous web 10 as can be produced with the inventive device 1. Coated web 10 that results at the end of the process is a carrier web T which is a fibrous web F in the form of a paper web which is characterized by at least one functional layer on one of its surfaces, in other words on its top surface 2 and/or on its bottom surface 3.

“Functional layer” is to be understood to be a layer which has been applied uniformly over the entire surface of the web in order to achieve additional functions or characteristics.

The following description relates to the provision of thermo-papers whereby carrier web T is provided through fibrous web F which subsequently is subjected to an on-line or off-line conversion process.

Coated web 10 is hereby characterized in a coordination system, through an extension in longitudinal and width directions which correspond to X- and Y-directions, as well as the height Z direction. The cross section clarifies the illustration in the YZ-plane.

In order to produce thermo-paper, which is to be understood to be a paper web which has at least one heat-sensitive layer which undergoes a change in color during a very brief contact with a heated element a functional layer in the form of a thermo-sensitive layer is applied to top side 2 and/or bottom side 3. FIG. 1a shows one arrangement of a coated web 10 in the form of a thermo-paper which is single coated on one side. Here, the application of a functional layer in the form of a thermo-sensitive layer 4 is seen on top surface 2 of fibrous web F which functions as carrier web T.

Regarding the actual designs and compositions of the individual thermo-sensitive layer 4 there are a plurality of options. These include at least one color generator and one color developer. These disperse in a fixing agent which does not melt, or which melts only insignificantly during heat development.

The base weight of the thermo-sensitive layer 4 in its final condition, that is in its dried condition, is in the range of 1 and 7 g/m², especially preferred 2 to 5 g/m².

FIG. 1b illustrates through a cross section, a further development of the coated fibrous web 10 of FIG. 1a, where in addition to thermo-sensitive layer 4 an additional protective layer in the form of a cover layer 5 is applied. This is normally a transparent layer.

FIG. 1c illustrates a further development of FIG. 1b whereby an additional functional layer 17 was applied between thermo-sensitive layer 4 and cover layer 5 which acts as a protective layer. This may also be characterized through thermo-sensitive properties or through additional properties describing the protective function of the thermo-sensitive layer.

FIG. 1d is characterized by an addition second functional layer 18. This too may be in the form of a thermo-sensitive layer or an additional protective layer.

While the FIGS. 1a through 1d illustrate paper, cardboard or other fibrous webs which are coated on one side, FIG. 1e is an example of a cross section of a fibrous web 10, single coated on both sides which is characterized by a functional layer in the form of thermo-sensitive layers 4 and 6 respectively on top surface 2 as well as on bottom surface 3 of carrier web T.

In this case too, the entire surfaces in the embodiments of top surface 2 and bottom surface 3 are respectively covered by the individual layers 4 and 6.

FIG. 1f illustrates one arrangement of a fibrous web 10 which is coated on both sides, for example, with two layers on top surface 2 and one layer on bottom surface 3.

FIG. 1g illustrates a further development of a coated fibrous web 10 according to FIG. 1f. Web 10 is characterized by a multiple coating, especially a double coating on both sides of carrier web T. Thermo-sensitive layer 4 and cover layer 5.1 are applied on top surface 2. Analogically, a thermo-sensitive layer 6 and a cover layer 5.2 are also applied on bottom surface 3.

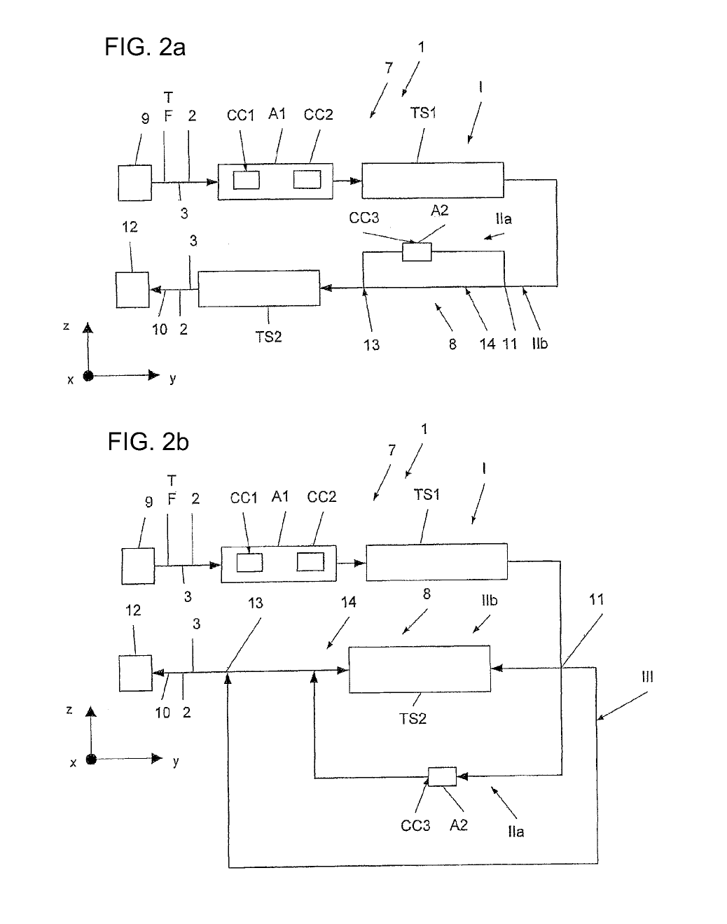

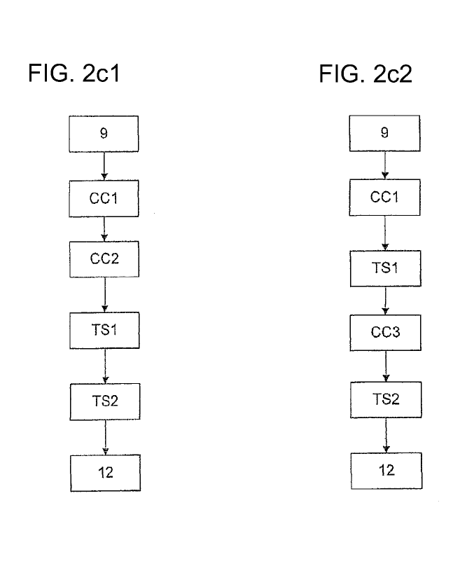

In order to be able to produce the different types of coated paper, cardboard or other fibrous webs 10 in the form of so-called thermo-papers depicted in FIGS. 1a through 1g simply and cost effectively, appropriate apparatuses 1 for coating and/or processing of surfaces according to the FIGS. 2 through 5 are utilized according to the present invention.

FIGS. 2a and 2b are schematically simplified illustrations of the basic construction and basic function of two especially advantageous and compact embodiments of inventive apparatus 1 for the production of coated paper, cardboard or other fibrous webs 10 with at least one functional layer in the form of a thermo-sensitive layer 4 or 6, which is designed and arranged to be suitable to produce carrier web T, or respectively fibrous web F which is coated either with a coating on both sides, that is a coating on the top surface 2 as well as on bottom surface 3, or with a multiple coating on one side. For this apparatus 1 includes two functional layer forming units 7 and 8 which, in the direction of travel of carrier web T which is to be coated can be engaged individually or in series, that is, successively to treat carrier web T. Each of the individual functional layer forming units 7 and 8 include at least one applicator device A1 and A2 in the embodiment of a multi-layer curtain coater with appropriate applicator nozzles or delivery slots, which are identified in the example as CC1, CC2, CC3 and CC4.

According to the inventive design the applicator nozzles which are suitable for multi-layer coating are not subjected to intermediate drying of the carrier web.

If fewer layers are to be applied than applicator nozzles or applicator slots are available the nozzles or slots which are not needed are not supplied with coating medium. In other words, they are not activated.

According to one embodiments of the present invention at least the first functional layer forming unit 7, viewed in the direction of travel of carrier web T, includes at least one multi-layer curtain coater with at least two such applicator nozzles which are located immediately following each other and which, viewed in the direction of travel of carrier web T apply coating to the web. This applicator device can also apply several coats simultaneously.

The second functional layer forming unit 8 in the direction of travel of carrier web T also includes an applicator device A2 of this type in the form of a multi-layer curtain coater. The functional layer forming units 7 and 8 also includes at least one drying section TS1 or TS2 respectively, each with at least one drying device. Drying section TS1 of first functional layer forming unit 7 is located after the curtain coater. According to the present invention the placement of the drying section TS2 occurs in a web path branch which allows bypassing of applicator device A2. Appropriate devices 14 for bypassing applicator device A2 of second functional layer forming unit 8 are provided for this purpose, for example in the embodiment of a bypass 14. Different web travel paths for carrier web T through apparatus 1 are available in order to realize the bypass function. These are realized through placement of the individual elements of functional layer forming units 7 and 8, as well as through appropriate guide rollers. The individual web path areas can be reduced to at least two. A first web path is characterized by the routing the web inside first functional layer forming unit 7 and is identified with I. The second web path is characterized by second functional layer forming unit 8 and is identified with II. This can be sub-divided into at least two partial regions Ia and IIb, whereby a first region Ia describes the path of carrier web T over applicator device A2, while IIb describes an additional web path which bypasses device A2. After the first functional layer forming unit 7 where the corresponding web travel region is identified with I, the web routing incorporates a branching 11 which enables routing of the first web path Ia over applicator device A2 and the routing of second web path IIb to bypass it, whereby the two web paths Ia and IIb are merged at 13. According to FIG. 2a drying section TS2 is located in web path IIb described by the bypass. It is however located after the merge 13 and according to FIG. 2b TS2 is located directly in the bypass of curtain coater CC3 before merge 13 of both web paths Ia and IIb. The two functional layer forming units 7 and 8 are each located between an unwind 9 for carrier web T, that is fibrous web F, and a rewinder 12 for coated fibrous web 10. The web path IIb extends to the rewinder 12.

According to an embodiment of the present invention variation the web routing between unwind 9 and rewinder 12 occurs with at least one directional change. This means the individual functional forming units 7 and 8 are located in apparatus 1 preferably in vertical offset planes. An example of a coordination system to clarify the individual directions is given. The X-direction corresponds as a rule to the longitudinal, or the machine direction, while the Y-direction describes the width direction and the Z-direction the height or vertical direction. It can be seen that the web passes through the individual functional forming units 7 and 8 in opposite directions, which means for unit 7 in a positive X-direction and for unit 8 in a negative X-direction. Based on the location of drying section TS2 in one web path region which is suitable for bypassing applicator device A2, especially the curtain coater, different operational modes of apparatus 1 are possible. These are characterized by the routing of carrier web T which is to be coated, through the different web path regions I and Ia in different directions.

The arrangement illustrated in FIG. 2a illustrates an especially compact basic arrangement; whereby the routing of carrier web T is characterized by at least one directional change between unwind 9 and rewinder 12. This is accomplished in that drying section TS2 is located in the bypass to the applicator device A2 of second functional layer forming unit 8, that the bypass however is located especially after merge 13 of the two web paths Ia and IIb. The web routing is characterized by a branching which is identified with 11 and which separates the possible web paths into the two web path segments, the web path Ia and one web path IIb which extends from the branching 11 over the merging 13 to rewinder 12. Drying section TS2 is then installed after merge 13. In addition the two functional layer forming units 7 and 8 are located in two different vertically offset planes. The extension of both units, viewed in the longitudinal direction and therefore in the X-direction, is essentially without offset relative to each other. Inside the individual functional layer forming units 7 and 8 the placement may occur also in a plane, or in several different offset planes in the vertical direction. In order to be able to especially utilize the theoretically available space in an optimum fashion for the provision of drying capacities, a plurality of drying devices, which are preferably arranged in a U- or V-shaped layout relative to each other, are provided especially in individual units 7 and 8, whereby the web routing varies accordingly. The individual functional units, especially applicator device A2 and drying section TS2 of second functional layer forming unit 8 are preferably located in the arrangement of web paths Ia and IIb which are offset relative to each other in a vertical direction. This allows for a relatively compact apparatus 1 in the axial direction.

The directional change of the web routing between the first and the second functional layer forming units 7 and 8 cause a reversal in the alignment of top side 2 and bottom side 3 so that now bottom side 3 is treated in second functional layer forming unit 8.

FIG. 2b in contrast shows an arrangement of drying section TS2 directly in the bypass to applicator device A2. In this case routing of carrier web T occurs in different directions over drying section TS2 in the different operational modes. With the arrangement in the bypass it must also be ensured that the drying section TS2 is being passed through after an application from applicator device A2. For this purpose at least one additional web path III is provided which permits an additional directional change in the web routing.

The inventive apparatus 1 permits different operational modes through control of the individual functional units, especially the multi-layer curtain coater. FIG. 2c1 clarifies the production of a carrier web T according to FIG. 1b, which is coated with two layers on one side. Here carrier web T is guided in accordance with one operational mode, consistent with web path I and IIb by bypassing the web path Ia. The multi-layer coater of first functional layer forming unit 7 applies a thermo-sensitive layer 4 with its nozzle or respectively with its applicator slot CC1 onto the surface of top side 2 of carrier web T, and at the same time applies protective layer 5 which acts as the cover layer, with applicator nozzle CC2. In order to be able to ensure the necessary dry content which is required to rewind coated fibrous web 10 an accordingly large drying capacity is to be provided. So that this does not have to be made available in first functional layer forming unit 7 alone, the drying capacity of second functional layer forming unit 8 which is not used for a coating application in this operational mode is also utilized. Carrier web T with the two layers 4 and 5 is guided here over first drying section TS1 and subsequently along web path IIb, and by bypassing applicator device A2 is guided over second drying section TS2. Viewed in machine direction, routing occurs opposite to the routing inside functional layer forming unit 7. This first operational mode is shown in the example of a flow diagram in FIG. 2c1, illustrating the stations inside apparatus 1 which are successively passed through, between unwind 9 and rewinder 12. In contrast, FIG. 2c2 illustrates the operational mode which theoretically feasible according to the basic configuration to produce a fibrous web 10 which is coated on both sides with one layer. In this case both functional layer forming units 7 and 8 with regard to their applicator devices A1 and A2 and the drying sections TS1 and TS2 are passed through successively. Here, the web travel paths I and Ia and a partial section of IIb which follows merge 13 are utilized. Specifically, a first layer in the form of thermo-sensitive layer 4 is applied to top side 2 of carrier web T by way of the applicator device inside first functional layer forming unit 7, for example, by way of the curtain coater and applicator nozzle CC1. Carrier web T then passes through drying section TS1 and then, due to the reversal of the web routing, passes the applicator device with the applicator nozzle CC3 with its bottom side 3. Subsequent to that carrier web T runs through drying section TS2 after which the dry content is achieved and rewinding can occur in rewinder 12.

FIGS. 2a through 2c illustrate an especially advantageous arrangement of the present invention with placement of individual functional layer forming units 7 and 8 in a vertical direction, offset relative to each other with directional change of the web routing through reversal of the orientation of top side 2 and bottom side 3 of carrier web T. However, a placement of the two functional layer forming units 7 and 8 successively in the longitudinal direction without a directional change in the web routing in an arrangement, which is not illustrated here, is also contemplated. However, a web turning device may be provided, in addition, in the merging area between functional layer forming units 7 and 8, in order to be able to produce the same material web types.

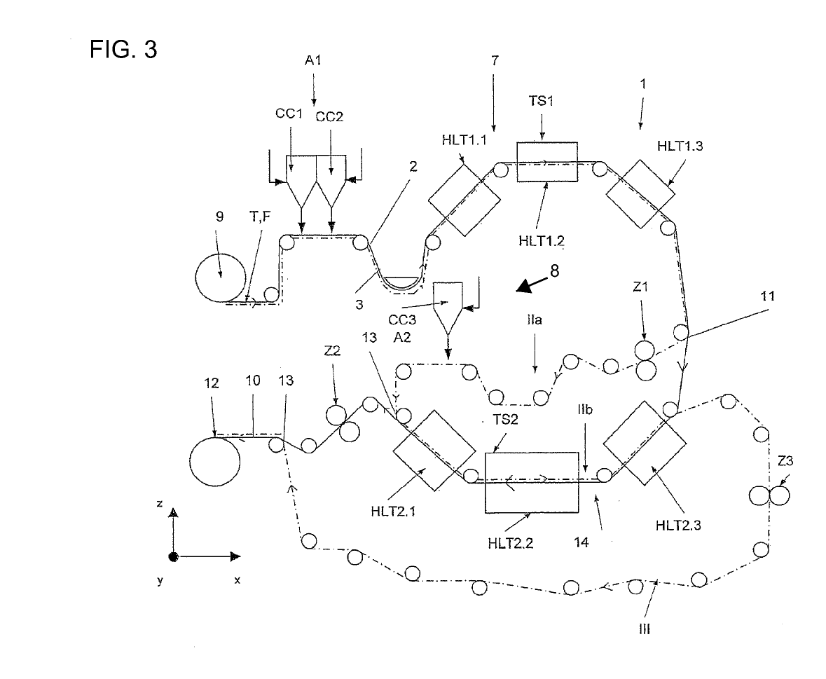

While FIGS. 2a through 2c illustrate a basic arrangement, FIG. 3 shows a concrete constructive embodiment in a schematically simplified illustration for an arrangement according to FIG. 2b. The same references are used for same elements. Here too, a coordination system is cited for clarification of the individual directions inside apparatus 1. In this arrangement the placement of functional layer forming units 7 and 8 is also in different vertically offset planes, whereby the extension in axial direction occurs preferably without offset relative to each other. The placement of drying section TS2 occurs in the bypass to applicator device A2 of second functional layer forming unit 8. This presents the necessity for additional web routing regions in order to allow routing of carrier web T in the individual operational modes in different directions through the drying section TS2. Here too, web path Ia is provided which describes the area in which the applicator device A2 is located, while the web path in the bypass area to applicator device A2 is identified with IIb. In addition, a third web path III is provided which, in an operational mode in which a layer is applied onto carrier web T by second functional layer forming unit 8, allows routing of carrier web T through drying section TS2 in an opposite direction by bypassing applicator device A2, when traveling to the rewinder 12.

The continuous line in FIG. 3 shows the web path inside apparatus 1 in a first operational mode, that is for the application of a multi-layer coating onto the top side 2 of carrier web T in the form of fibrous web F, and the utilization of the drying capacities of both functional layer forming units 7 and 8. This arrangement utilizes web path regions I and IIb. The web path regions Ia and III are not considered. In the second operational mode, that is when applying at least one layer onto top side 2 and bottom side 3, fibrous web F is carried over web path Ia and subsequently through section TS2 and web path III to rewinder 12. Here fibrous web F undergoes several directional changes. In the web routing individual guide elements and guide rolls are positioned for this purpose so that they always facilitate a directional reversal or change between first drying section TS1 of unit 7 and applicator device A2 of second functional layer forming unit 8. Subsequent to applicator device A2 drying section TS2 is passed through in an opposite direction and after another directional reverse, after drying section TS2, the web is routed back to rewinder 12. In order to realize the opposite travel direction through drying section TS2 appropriate means to guide the carrier web are provided in the form of guide elements and guide rolls which permit these individual directional changes. In order to be able to move fibrous web F through apparatus 1, appropriate pulling devices Z1 through Z3 are required. These are preferably always located after drying sections TS1 and TS2 of functional layer forming units 7 and 8. In order to ensure an especially optimum layout in the arrangement according to FIG. 3, the placement of a first pulling device Z1 occurs in web path Ia before applicator device A2 and placement of a second pulling device Z2 following second drying section TS2.

An additional pulling device Z3 is located after drying section TS2 in web path III.

The individual drying sections TS1 and TS2 each include at least one drying device, preferably a plurality of in-series drying devices HLT1.1 through HLT1.3 and HLT2.1 through HLT2.3 which operate with hot air, and which are heated by gas or steam. The drying devices depicted in FIG. 3 are arranged so that the routing of carrier web T between them occurs over guide rolls.

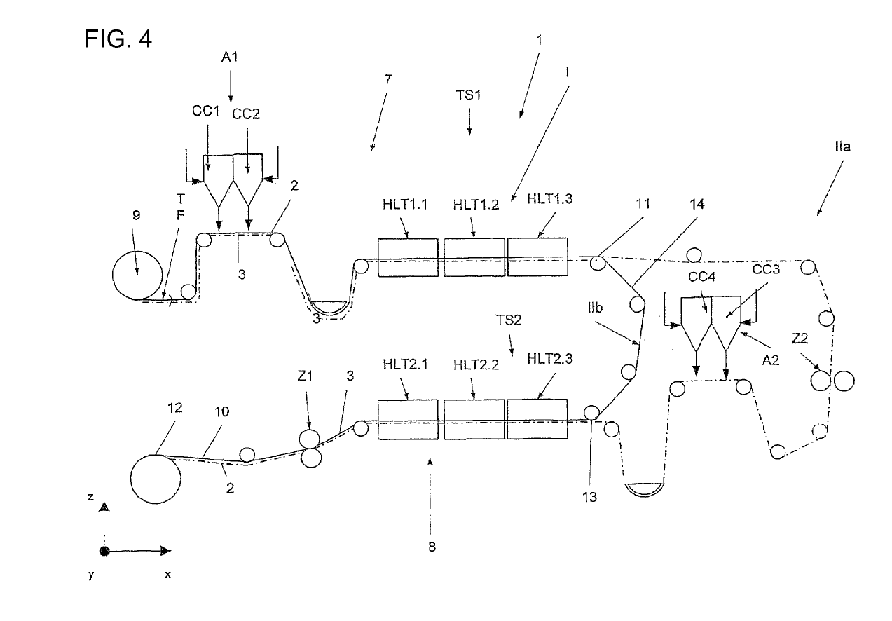

In another arrangement according to FIG. 4 the placement of the individual drying sections TS1 of first functional layer forming unit 7 and TS2 of second functional layer forming unit 8 occurs preferably in the form of tunnel dryers, without the intermediate placement of guide rollers, located in series in two vertically offset planes. The arrangement according to FIG. 4 corresponds essentially to the arrangement according to FIG. 2a whereby routing in the bypass is without the arrangement of dryer section TS2, and drying section TS2 is quasi located after the branching 11, or respectively after the merging 13. This arrangement facilitates a highly space saving layout in an axial direction. Here, applicator device A2 of second functional layer forming unit 8 is located in the axial direction, offset relative to the extension of first functional layer forming unit 7.

The arrangement illustrated in FIG. 4 is characterized as having web paths I, Ia, and IIb described in FIG. 2a. In this example, routing after first drying section TS1 at branching 11 occurs either over additional guide rolls to the next applicator device A2, in this case with applicator nozzles CC3 and CC4, whereby the routing occurs in a way that now the bottom side is coated and is subsequently routed over drying section TS2 to rewinder 12. Otherwise the routing occurs according to the first operational mode over the first segment of an entire drying section which is embodied by drying section TS1 and in addition by utilizing the drying capacity of second functional layer forming unit 8, through drying section TS2 by bypassing applicator device A2, that has applicator nozzles CC3 and CC4.

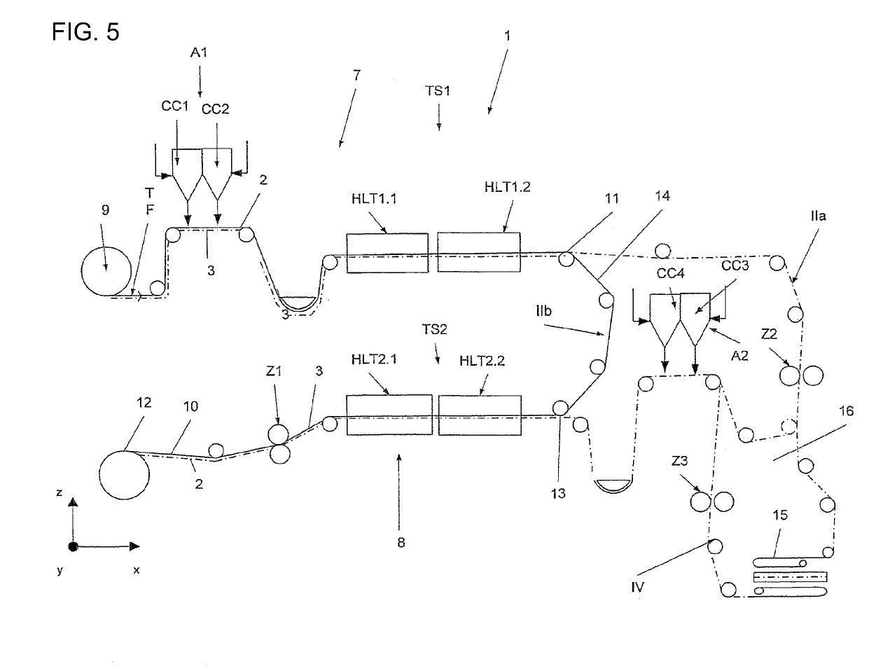

The basic principle described in FIGS. 2a and 2b and the arrangements illustrated in FIGS. 3 and 4 are also expandable with additional functional units, for example a web turning device 15. Web turning device 15 is located preferably in a bypass in the path between first functional layer forming unit 7 and second functional layer forming unit 8. This is identified with 16 in FIG. 5. In a further advancement of the arrangement according to FIG. 4, FIG. 5 illustrates an arrangement according to the basic principle described in FIG. 2a, with an additional web turning device 15. An additional web path region IV is provided, which creates bypass 16. Functional layer forming units 7 and 8 are offset in the vertical direction relative to each other, so that the routing of carrier web T in them occurs in opposite directions. A branching 11 in the web path is located after first functional layer forming unit 7 and is connected with web path region IIa, IIb where applicator devices A2 of second functional layer forming unit 8 are located, and in addition a bypass to the region which forms a partial segment of web path IIb. Here too drying section TS2 is located after merge 13 in web path IIb.

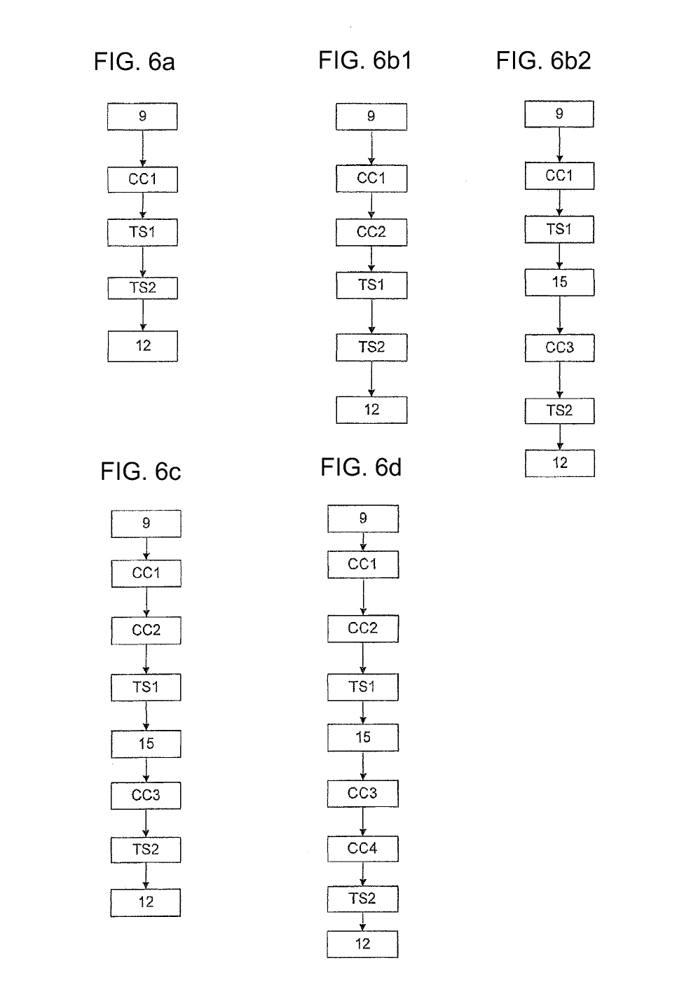

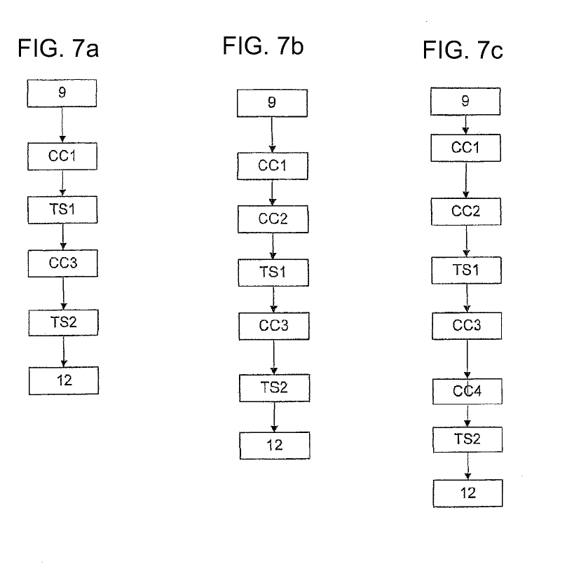

Due to the multi-layer curtain coater with applicator nozzles CC3, CC4 which is provided in second functional layer forming unit 8 a plurality of operational modes present themselves which are illustrated in FIGS. 6a through 6d with respect to single sided coating of carrier web T, while the individual process steps for double-sided coating of carrier webs are illustrated in FIGS. 7a through 7c.

FIG. 6a is a flow diagram of the individual functional units which interact with carrier web T and which are passed through successively. For the single sided coating application onto top side 2 of carrier web T an activation occurs of applicator device A1 in the embodiment of the multi-layer curtain coater including applicator nozzles CC1 and CC2, with in this example CC1 and CC2 is deactivated. Carrier web T with the layer which was applied through CC1 and which is preferably a thermo-sensitive layer 4 runs through drying section TS1, in this example individual drying devices HLT1.1 and HLT1.2, and subsequent to this, while bypassing curtain coater CC3 and CC4 travels over the bypass, through drying section TS2, which in this example includes the individual dryer devices HLT2.1 and HLT2.2 in the embodiment of hot air dryers. After this coated fibrous web 10 is rewound. The dryer units HLT2.1 and HLT2.2 of second drying section TS2 do not have to be activated.

FIG. 6b1 is a flow diagram of the individual process steps for the production of a multi-layer coating, especially a two-layer coating. According to a first arrangement an application with the applicator nozzles CC1 and CC2 is contemplated, whereby CC1 applies the thermo-sensitive layer and the required cover layer 5, in form of the protective layer, is provided by CC2. Subsequently the entire coating is brought to the required dry content in the two drying sections TS1 and TS2 of the two functional layer forming units. According to a second alternative arrangement according to FIG. 6b2 the individual layers are created by applicator devices A1 and A2 of both functional layer forming units 7 and 8. For this purpose one of the two applicator devices of first functional layer forming unit 7 is deactivated, preferably CC2 and the application of the thermo-sensitive layer is made by CC1. After passing through drying section TS1 the web is turned on web turning device 15 before traveling into the applicator device of second functional layer forming unit 8, so that again the top side 2 can be provided with a coating through one of the individual applicator nozzles CC3 and CC4. One of these two devices assumes this function and the hereby coated carrier web T is subsequently supplied to drying section TS2 and runs through the two hot air dryers HLT2.1 and HLT2.2.

Now, in order to be able to provide a multi-layer coating on top side 2, the arrangement according to FIG. 6b2 is expanded so that an additional applicator device is active in one of the two functional layer forming units 7 or 8. Accordingly, according to FIG. 6c a triple-layer fibrous web 10 can be produced by way of applicator nozzles CC1 and CC2 after passing through drying section TS1 and web turning device 15, by way of nozzles CC3 or CC4 and passing through drying section TS2. In order to provide a further increase, the additional nozzle CC4 of second functional layer forming unit 8 may also be activated, as shown in FIG. 6d.

In contrast, FIG. 7a illustrates a first option to produce a carrier web T which is coated on both sides, whereby each time one layer in the form of a thermo-sensitive layer 4 or 6 is applied on each side. Accordingly, an application is made over first thermo-sensitive layer 4 on top side 2. This is routed through drying section TS1 and brought to the required dry content in order to subsequently receive the required additional thermo-sensitive layer 6 on bottom side 3, which is then brought to the required dry content in the following drying section TS2.

In order to achieve a carrier web T, in yet another advancement, which is coated on both sides and which is coated with a double layer on one side, first functional layer forming unit 7 is activated in this example, and the required cover layer 5 is applied subsequent to thermo-sensitive layer 4, whereby the two layers are supplied to drying section TS1 and are dried there. Subsequent to this bottom side 3 is coated by applicator device A2 of second functional layer forming unit 8 and is dried through drying section TS2, whereby here also a further drying of the multi-layer coating on top side 2 occurs.

In a further advancement according to FIG. 7b, FIG. 7c illustrates the additional activation of second applicator nozzle CC4 of second functional layer forming unit 8.

The inventive solution demonstrates the ability to produce various types of coated paper, cardboard or other fibrous webs 10, especially carrier webs with thermo-sensitive coating 4 and 6 by way of two functional layer forming units 7 and 8 and their intelligent linkage, as well as through the expansion of additional functional units. The inventive solution is not limited to these arrangements. The basic configuration is based on two functional layer forming units 7 and 8 through which a large number of multi-layer coating configurations can be achieved. The only requirement exists in the placement of the second functional layer forming unit 8 in a way that applicator device A2 of the second functional layer unit can be bypassed. A plurality of constructive possibilities exists. Based on the required different directions for allocation to the individual sides of a carrier web T however, an arrangement with vertical offset in the area of the axial extension of the first functional layer forming unit 7 for second functional layer forming unit 8 clearly presents itself.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION

1 Apparatus
2 Top side
3 Bottom side
4 Thermo-sensitive layer
5 Cover layer
6 Thermo-sensitive layer
7 First functional layer forming unit
8 Second functional layer forming unit
9 Unwind
10 Coated fibrous web
11 Branching
12 Rewinder
13 Merging
14 Means to bypass the applicator device of the second Functional layer forming unit
15 Web turning device
16 Bypass
17 Functional layer
18 Functional layer
A1 Applicator device
A2 Applicator device
CC1 First applicator nozzle of the curtain coater of the first functional layer forming unit
CC2 Second applicator nozzle of the curtain coater of the first functional layer forming unit
CC3 First applicator nozzle of the curtain coater of the second functional layer forming unit
CC4 Second applicator nozzle of the curtain coater of the second functional layer forming unit
TS1 Drying section
TS2 Drying section
HLT1.1-HLT1.3 Drying devices
HLT2.2-HLT2.3 Drying devices
Z1-Z3 Pulling devices
I, Ia, IIb, III, IV Web paths
X Longitudinal direction
Y Width direction
Z Height direction

What is claimed is:

1. An apparatus to produce one of coated paper, cardboard and other fibrous webs with at least one thermo-sensitive layer as a functional layer through the application of at least one thermo-sensitive coating medium onto a carrier web, the apparatus comprising:
a plurality of functional layer forming units including a first functional layer forming unit and a second functional layer forming unit, at least one of said plurality of functional layer forming units applying the thermo-sensitive coating medium to the carrier web, said plurality of functional layer forming units each including:
at least one applicator device; and
a drying section, said at least one applicator device of said first functional forming unit being a multi-layer curtain coater with at least one delivery nozzle, said drying section of said first functional layer forming unit being located after said multi-layer curtain coater, said at least one applicator device of said second functional layer forming unit being a multi-layer curtain coater with at least one delivery nozzle with said drying section of said second functional layer forming unit being located thereafter, the apparatus being configured to have a first web path that includes said applicator device of said second functional layer forming unit, and a second web path that does not include said applicator device of said second functional layer forming unit; and
means to bypass said applicator device of said second functional layer forming unit by directing the web in a web direction along said second path.

2. The apparatus of claim 1, wherein said means to bypass said applicator device include at least one of a guide and control elements to guide the carrier web, said at least one of a guide and control elements being located and configured to create a branching in the web routing after said first functional layer forming unit between said first web path that is proximate said applicator device of said second functional layer forming unit and said second web path that is not proximate said applicator device of said second functional layer forming unit, said means to bypass said applicator device also including a merging of said first web path and said second web path.

3. The apparatus of claim 2, wherein said drying section of said second functional layer forming unit is located in the web direction after said means for bypassing said applicator device.

4. The apparatus of claim 1, further comprising at least one pulling device located after said drying section of said second functional layer forming unit, said means to bypass said applicator device being located and configured to create a branching in the web path after said first functional layer forming unit in the web direction and a merging before said drying section of said second functional layer forming unit.

5. The apparatus of claim 1, wherein said drying section of said second functional layer forming unit is located in said second web path, said means to bypass said applicator device of said second functional layer forming unit being located and configured to guide the carrier web in an opposite direction to the direction of one of said first web path and said second web path through said drying section of said second functional layer forming unit thereby defining at least one additional web path.

6. The apparatus of claim 5, further comprising at least one pulling device which is located before said applicator device of said second functional layer forming unit and after the branching in the web direction.

7. The apparatus of claim 1, wherein said applicator device and said drying section in each said functional layer forming unit are configured so that the carrier web is guided inside each said functional layer forming unit without a directional change of the carrier web as viewed in a longitudinal direction of the apparatus.

8. The apparatus of claim 7, wherein said applicator device and said drying section in each said functional layer forming unit are located in a horizontal plane.

9. The apparatus of claim 7, wherein said horizontal plane of said first functional layer forming unit and said horizontal plane of said second functional layer forming unit are vertically offset relative to each other.

10. The apparatus of claim 1, wherein said second functional layer forming unit follows said first functional layer forming unit in a longitudinal direction of the apparatus so that the web direction and routing of the carrier web in the longitudinal direction of the apparatus is without reversal of an initial web direction.

11. The apparatus of claim 10, wherein said plurality of functional layer forming units are located in a horizontal plane.

12. The apparatus of claim 1, wherein at least one of said drying section of said first functional layer forming unit and said drying section of said second functional layer forming unit has a drying capacity that is selected to provide a pre-defined dry content of a multiple layer coating that has been applied by said at least one applicator device.

13. The apparatus of claim 1, further comprising:
a web turning device positioned in the web path between said first functional layer forming unit and said applicator device of said second functional layer forming unit; and
a bypass means within which said web turning device is located.

14. The apparatus of claim 1, further comprising:
a coating medium supply system; and
at least one coating medium feed line through which the coating medium from said coating medium supply system flows, said applicator device of at least one of said first functional layer forming unit and said second functional layer forming unit being a multi-layer curtain coater having at least one applicator nozzle that extends in a width direction of the carrier web, said multi-layer curtain coater receiving the coating medium from said at least one coating medium feed line.

15. The apparatus of claim 14, wherein at least one additional coating medium supply system for supplying a different coating medium to said multi-layer curtain coater, said coating medium supply system and said at least one additional coating medium supply system being selectively accessed, at least one of said coating medium supply system and said at least one additional coating medium supply system containing a thermo-sensitive coating medium.

16. The apparatus of claim 14, wherein said multi-layer curtain coater includes at least one break line at which the coating medium is delivered in a free fall onto a surface that is to be coated and said break line is formed by one of a slot die, a slide die, and a slanted slide plate which is allocated to said applicator nozzle.

17. A method to operate an apparatus to produce one of a coated paper, a cardboard and other fibrous webs, the method comprising the steps of:
applying at least one thermo-sensitive layer as a functional layer to a carrier web through the application of at least one of a liquid and a paste-like coating medium onto the carrier web, the apparatus including a plurality of functional layer forming units including a first functional layer forming unit and a second functional layer forming unit, at least one of said plurality of functional layer forming units applying the thermo-sensitive coating medium to the carrier web, said plurality of functional layer forming units each including at least one applicator device and a drying section, said at least one applicator device of said first functional forming unit being a multi-layer curtain coater with at least one delivery nozzle, said drying section of said first functional layer forming unit being located after said multi-layer curtain coater, said at least one applicator device of said second functional layer forming unit being a multi-layer curtain coater with at least one delivery nozzle with said drying section of said second functional layer forming unit being located thereafter, the apparatus being configured to have a first web path that includes said applicator device of said second functional layer forming unit, and a second web path that does not include said applicator device of said second functional layer forming unit; and
bypassing said applicator device of said second functional layer forming unit by directing the web in a web direction along said second path, the apparatus being operated in a plurality of operational modes based on control of the web path and components of said plurality of functional layer forming units.

18. The method of claim 17, further comprising the steps of:
successively running the carrier web in a first operational mode through said first functional forming layer unit with at least one first layer being formed on the carrier web, and then through said second functional layer forming unit with a second layer being formed thereon; and
alternatively successively running the carrier web in a second operational mode through said first functional layer forming unit with at least one first layer being formed on the carrier web, and then through said second functional layer forming unit without another application being applied to the carrier web.

19. The method according to claim 18, wherein the carrier web in said second operational mode is routed through the first functional layer forming unit with at least two layers being applied thereto, and the method additionally including the step of utilizing a drying capacity of said second functional layer forming unit as the web is routed through said drying section of said second functional layer forming unit.
